(19) United States
(12) Patent Application Publication
(10) Pub. No.: US 2021/0086193 A1
(43) Pub. Date: Mar. 25, 2021

(54) PROCESS AND APPARATUS FOR CLEANING AND DISCHARGING WASTE SOLIDS FROM CONTAMINATED FLUIDS

(71) Applicant: ZERO GRAVITY FILTERS, INC., Brighton, MI (US)

(72) Inventors: Blaine Frank SEVERIN, Brighton, MI (US); James T. BRUHN, Brighton, MI (US)

(21) Appl. No.: 16/582,749

(22) Filed: Sep. 25, 2019

(51) Int. Cl. B03C 1/28; B01D 21/01; B01D 21/00

(52) U.S. Cl. CPC B03C 1/284; B01D 21/0009; B01D 21/01; B03C 1/288

(57) ABSTRACT

An assembly and process for treating contaminated fluid. The assembly has a reactor including a tank with an internal weir, a low speed mechanical mixer, and means for delivering fluids to subsequent stages. A first stage has polymer make-up and coagulant feed units plus a dilution means which deliver modified contaminated fluid to a second stage with a low impact feed pump to preserve flocculant integrity. In a third stage, first sub-assemblies of self-cleaning magnetic shuttles capture at least some of the magnetic flocculant that escapes in the clarified effluent. In a fourth stage, second magnetic drum-type sub-assemblies separate magnetite particles from the flocculant, return the magnetite to the reactor, and send the non-magnetic solids to a fifth stage—dewatering. This stage has a receptor for accommodating solids that are optionally treated with a coagulant and flocculant to produce solids to be transported to a landfill.

### BACKGROUND OF THE INVENTION

### 1. Field of the Invention

This disclosure relates generally to a clarification system including a process and an apparatus that remove suspended solids from contaminated fluids using magnetic separation devices.

### 2. Background Art

In many industrial environments, contaminated liquids have non-ferrous and ferrous components. Such environments may include for example transportation and steel, HVAC installations, oil and gas, food, chemical pulp and paper. Typically, non-ferrous components may be at least partially removed by conventional filtration methods. Use of such methods may result in some improvement, especially if fortified by a backwashing step. To remove ferrous components, in-line high intensity magnetic techniques can be used. As a result of techniques for removing non-ferrous and ferrous materials, a relatively clean solution often results.

Known magnetic separation devices units include a shuttle-type magnet system (see, e.g. commonly owned U.S. Pat. No. 7,073,668 which is incorporated by reference) and a rotating drum-type magnet system. Such systems treat industrial fluids such as cutting fluids or process wash water from automobile manufacture paint applications. Those applications typically involve large volumes of contaminated fluid that require treatment to remove contaminants like magnetic metal shavings, “cuttings” or welding debris.

### SUMMARY OF THE INVENTION

In one aspect, the disclosed system includes a process and an apparatus that involves the addition of magnetic materials such as powdered elemental iron (Fe⁰) or magnetite (Fe₂O₃) to contaminated fluids such as water or wastewater that is modified with additives including coagulant aids (defined later) and organic polymers (also defined later). Such additives cause suspended solids in the contaminated water or wastewater to agglomerate or flocculate around the magnetic material, thus transforming the flocculant into a magnetic state.

To accomplish this, the apparatus in one embodiment includes an assembly that has two subassemblies which form an automated, self-cleaning magnetic system that almost completely clarifies contaminated water or wastewater from which suspended solids are removed. As a result, lifecycle costs are reduced and adverse environmental footprints are minimized.

### BRIEF DESCRIPTION OF THE DRAWINGS

FIG. 1 is a partially cut-away perspective view of a magnetic separator which exemplifies an earlier generation first magnetic separator sub-assembly;

FIG. 2 is a process flow schematic utilizing two sub-assemblies—a first magnetic separator sub-assembly and a second drum-type magnetic sub-assembly;

FIG. 3 is a perspective view of the first magnetic separator sub-assembly in a filtering mode that illustrates a valve configuration with an outlet port open and a solid purge port closed, with magnetic shuttles positioned below a baffle plate;

FIG. 4 is a perspective view of the first magnetic separator sub-assembly in a cleaning mode that illustrates a valve configuration with an outlet port closed and a solid purge port open, with magnetic shuttles positioned above a baffle plate;

FIG. 5 is a perspective view of a second sub-assembly that includes a magnetic drum and a logic module.

### DETAILED DESCRIPTION OF THE PREFERRED EMBODIMENT(S)

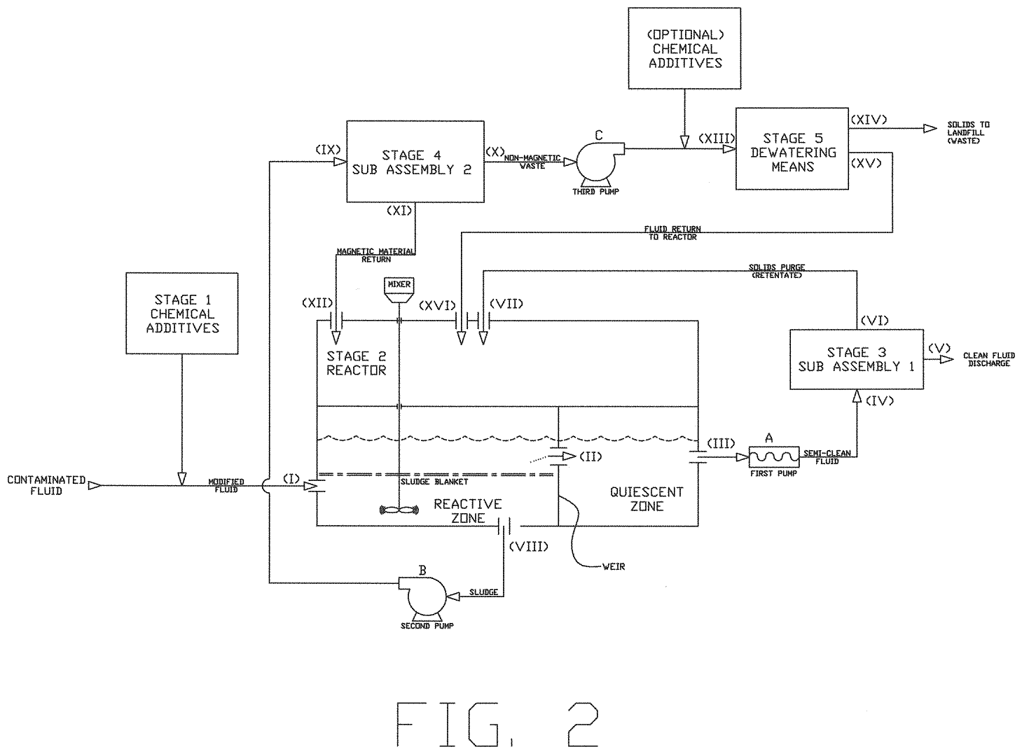

In one embodiment of a magnetic clarification system with an assembly in which are practiced multiple process steps, a purification process begins with contaminated fluid being modified with chemical additives at Stage 1 (FIG. 2). Modified fluid then enters Stage 2: a reactive zone of a reactor at inlet port (I). After crossing a weir through port (II), semi clean fluid enters a quiescent zone. From there, the semi clean fluid leaves the reactor through port (III) and is propelled by gravity or a first pump (A) towards Stage 3: a first sub-assembly which has one or more shuttle-type magnets. The semi clean fluid is passed through the shuttle-type magnetic first sub-assembly until that sub-assembly enters a cleaning step. During the cleaning step, at least some metallic debris is collected.

Continuing with reference to FIG. 2, a solids purge step involves fluid carrying that metallic debris (“retentate”) leaving the first sub-assembly through port (VI) before being directed to reactor port (VII) of the reactive zone for recycling. To control the mass within the sludge blanket, solids may be removed as needed from the reactor via port (VIII). The fluid containing solids pass through a second pump (B) before being transported to Stage 4: a second sub-assembly through port (IX). This second sub-assembly includes a rotating drum-type magnet sub-assembly. Passage of the fluid from port (IX) through the pump disrupts the physical attraction between the non-magnetic material and the magnetic material. The second sub-assembly separates the magnetic material for reuse in the reactor and allows the non-magnetic material to go to de-watering before disposal. This contrasts with conventional practices, which may entail the non magnetic fluid being re-used and the magnetic material being sent to waste disposal.

Discharge fluid containing the non-magnetic suspended solids from the second sub-assembly leaves via port (X). From there, the discharge fluid passes through a third pump (C). Optionally, chemical additives may further modify the discharge fluid. Further modified fluid then passes into Stage 5: a de-watering means. Such means may include a de-watering apparatus. Remaining fluid leaves Stage 5 via port (XV) and returns to the reactor through port (XVI). Solids leave Stage 5 through port (XIV) for delivery to a disposal site such as a landfill.

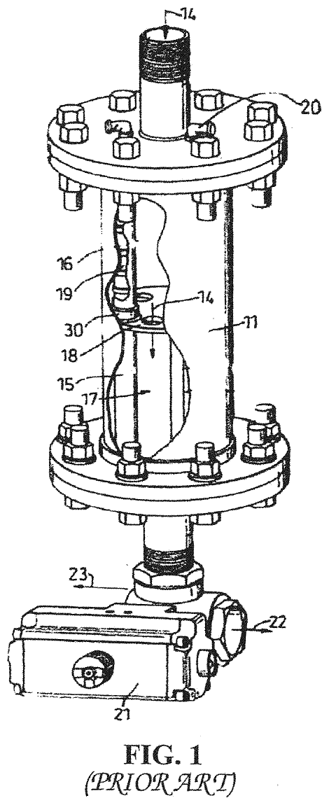

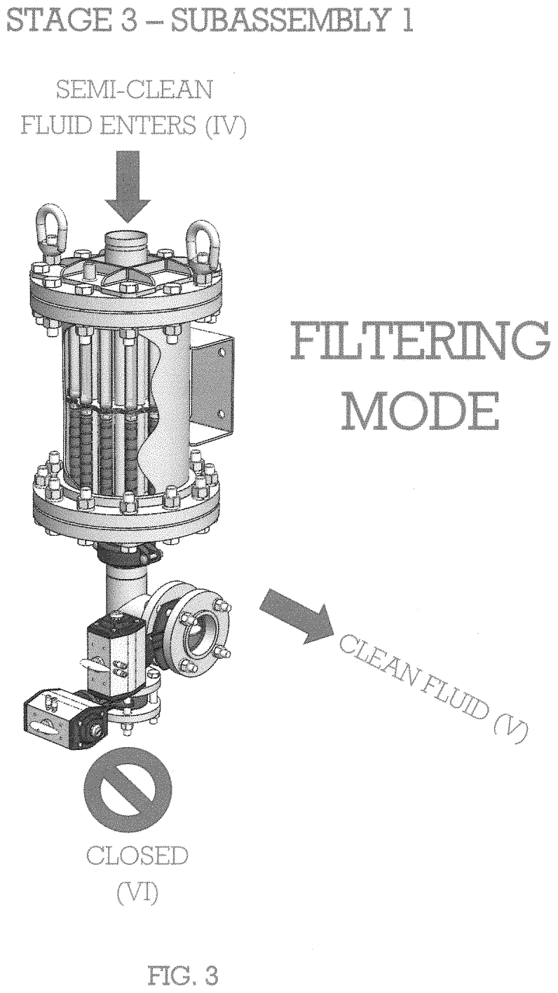

In more detail, one embodiment of a first sub-assembly (Stage 3) is depicted in FIGS. 1, 3 & 4. That shuttle-type magnetic sub-assembly has a tube-within-a-tube structure in which a number (usually 1 to 30) of smaller diameter tubes 15 are flow-isolated within a larger diameter external tube 11. The external tube is typically oriented generally vertically. The smaller inner pipes or tubes 15 are also aligned generally vertically. The contaminated fluid to be treated flows within a volume 17 between the external wall 11 and the inner pipe(s) 15. The primary flow of the contaminated fluid to be treated is from the top region 14 to the bottom region of the first sub-assembly. Treated fluid leaves the first sub-assembly either through a normal effluent forward flow port 22 or a waste flow port 23, as determined by a flow control actuator 21. In some embodiments, the actuator 21 is operated by pneumatic air pressure (not shown).

One feature of the first sub-assembly is a horizontal baffle plate 18 that is mounted approximately in the middle of the external pipe 11. The baffle plate 18 has a profiled cut edge with curved indentations to allow fluid to pass along the inside wall from the upper portion of the first sub-assembly to the bottom and perforations to allow passage of the inner pipes 15.

In one embodiment of the first sub-assembly, one tube 15 houses a series of cylindrical magnets (“magnetic shuttles”) 19 that occupy about one-half the volume of the tube 15. During normal forward flow of fluid to be treated, the magnets 19 occupy the bottom half of the tube 15 below the baffle plate 18. Metallic particles are captured by magnetic forces outside the bottom half of the tube 15 by those particles adhering to the external wall of the tube 15. Forward flow of modified fluid proceeds through the discharge port 22.

In a cleaning step, first the flow actuator 21 changes the flow passage from normal flow to waste flow 23 (FIG. 1). After a brief period, pneumatic pressure (normally pressurized air) is applied simultaneously to the bottom of each tube 15. Such pressure drives the magnetic shuttles 19 in the tube 15 upwardly to a position above the baffle plate 18. The metallic fines that reside in the bottom of the first sub-assembly are unable to follow the magnets due to the forward flow of fluid and the restrictive presence of the baffle plate 18. Collected particles move with the fluid flow into the waste line, leaving the bottom of the first sub-assembly substantially free of solids. Shortly thereafter, pneumatic pressure is applied to the top of each tube 15. The magnetic shuttles 19 are moved back to their normal position below the baffle plate 18. The fluid flow actuator changes the direction of flow to normal forward flow 22 (FIG. 1.

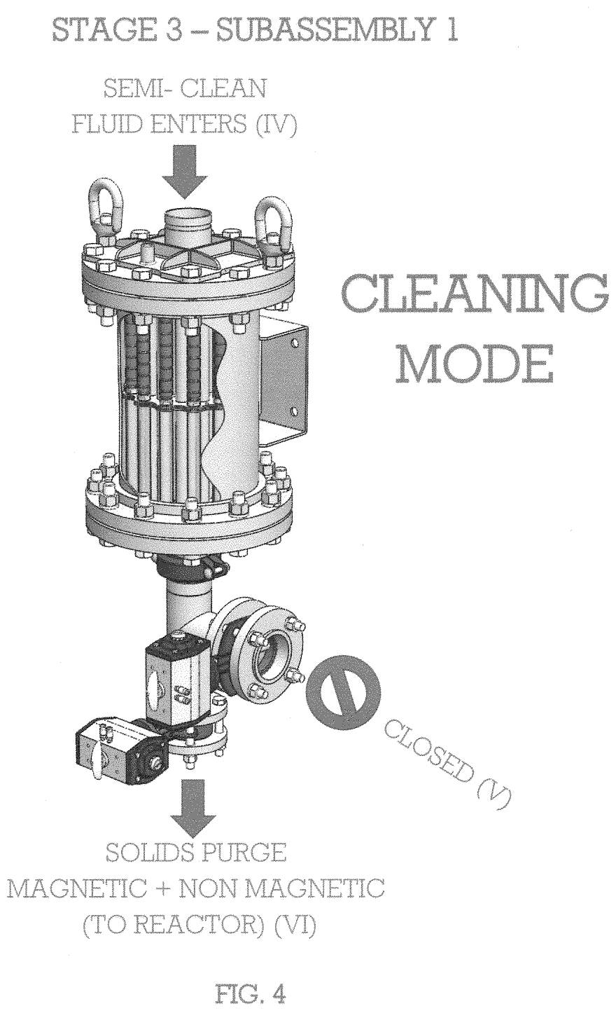

FIGS. 3 and 4 depict an example of an improved first sub-assembly that treats contaminated industrial fluids. Contaminated fluids to be treated enter the first sub-assembly at an influent port. Pneumatic air pressure is applied to the top of the assembly to position the magnetic shuttles in the lower portion, beneath the baffle plate. The valves are then in a normal flow condition (FIG. 3). The cleaning cycle is initiated as a timed event by a logic module that shifts the magnetic shuttles and rotates flow control actuators. An actuator that may be electrically or pneumatically energized changes the direction of flow from normal discharge to waste discharge. Pneumatic air pressure moves the magnetic shuttles from the bottom region of the first sub-assembly to the top region of the tube 15. After a brief delay, the magnetic shuttles are moved back beneath the baffle plate 18. At a later time, the logic module rotates the actuators to a filtering mode (FIG. 3). The first sub-assembly then returns to normal flow through the forward flow discharge port.

In one innovative embodiment of the assembly of first and second sub-assemblies, the purge line through which some solids travel (FIG. 2) from the first sub-assembly is connected to the influent port (FIG. 3) of the second sub-assembly via the reactor (Stage 2). This contrasts with conventional practices, in which the solids purge line from the first sub-assembly is connected directly to the second sub-assembly. As such, the sub-assemblies can run in parallel, rather than in series. Further the sub-assemblies can run independently of each other.

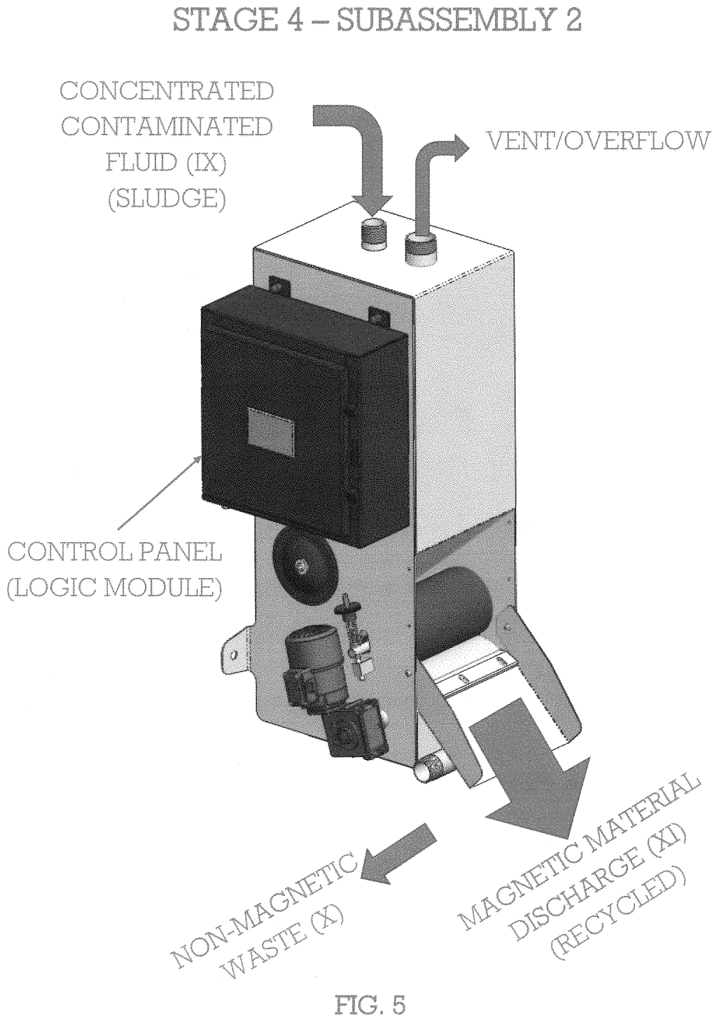

Continuing with reference to FIG. 5, the second sub-assembly has two primary sections—a top/inlet tank and a lower pan/drum tank or reservoir with a magnetic drum driven by a motor gearbox. A single second sub-assembly can accommodate the effluent of two or more first sub-assemblies.

Referring further to FIG. 2, contaminants remaining after treatment by the first sub-assembly and the reactor enter the second sub-assembly at an influent port (IX). Such fluids are transiently retained in the reactor within a reservoir behind a weir. Any magnetic material remaining after passage through the second sub-assembly (FIG. 5) is delivered to a discharge chute by the drive motor, a magnetic drum and a scraper mechanism.

One purpose of the assembly is to use the second sub-assembly (Stage 4) to maintain an acceptable solids content in the reactive blanket. The pump (B) in one embodiment is a high shearing pump. It effectively destroys the sludge flocculant, releasing magnetic particles from the non-magnetic solids. The waste sludge enters the second sub-assembly at inlet (IX), which collects the magnetic particles and returns them to the reactive blanket (XI-XII).

The assembly substantially in the disclosed form is preferably employed when there are no other viable means to remove contaminants and recover useful fluids.

One form of the assembly is mounted on a platform. This provides a compact, mobile, yet effective and reliable embodiment of a magnetic clarification process.

It will thus be appreciated that use of the assembly involves magnetic clarification. In several embodiments of the present disclosure, contaminated water or wastewater is combined in Stage 1 with polymeric flocculants and coagulant aids in the presence of magnetite. The magnetic flocculent is removed by magnetic forces in the first sub-assembly. In one example, flocculated iron hydroxide was generated from pH stabilized ferric chloride (250 mg/l) and treated with a cationic polymer. A magnetic wand immersed in the fluid showed no response. A similar floc was produced, this time adding a small aliquot of magnetite. The flocculant was rapidly removed by the magnet.

The disclosed assembly has several novel aspects over known technology. These include self-cleaning magnets and the fact that the assembly is self-contained, may be mobile and is simple to maintain.

### Preferred Embodiment of the Invention is

To summarize before a more detailed discussion, one variant of a process flow is through the first sub-assembly and a parallel process flow is through a second sub-assembly as depicted in FIG. 2. In that variant, there is a chemical additives step (Stage 1), a tank reactor (Stage 2), multiple processing steps (Stages 3-4), and a solids dewatering step (Stage 5).

Stage 1: The first process step (chemical make-up) has for example one or more ways (e.g. pumps) to introduce one or more polymers make-up and/or coagulants. The additives may be diluted with water if needed.

Stage 2: The core reactor in one variant is a tank (termed “reactor”) with for example a weir, a low speed mechanical mixer, and various ports required for delivering fluids to or receiving fluids from Stages 3-5.

Stage 3: This stage has one or more first magnetic sub-assemblies (discussed later in more detail). Associated with or between Stages 2 and 3 is a first pump (A) (e.g., a stator-type 175 gpm pump @ 30 psi) to preserve floc integrity followed by a bank (one or more, nominally 3) of first sub-assemblies to capture magnetic flocculant that may escape in the semi-clean fluid that emerges from Stage 2.

Stage 4: The fourth process step has for example a second pump (B) (e.g., a 10 gpm centrifugal pump @ 30 psi) followed by a bank (e.g., 2) of magnetic drum-type second sub-assemblies. Some purposes of this stage include further separating of magnetite particles from the flocculant, returning magnetite to the reactor, and sending the non-magnetic solids to the dewatering stage.

Stage 5: The dewatering stage preferably is a receptor such as a membrane bag housed within for example a dumpster for later transport to a landfill. Solids sent to dewatering may require additional chemicals, e.g. coagulants and flocculants to improve the dewatering process.

One variant of the overall purification process will now be discussed in more detail with primary reference to FIG. 2. Contaminated fluid is optionally modified with chemical additives to produce a modified fluid, which enters the reactor at the influent port (FIG. 2, I). By adding magnetic iron, the sedimentation of the floc is increased by increasing the overall density of the floc. Mechanical agitation is required to gently lift the dense floc and form a reactive blanket. The large number of floc particles in the reactive blanket improves the contact between new floc entering the reactor at port (I) and improves the capture of the newly added floc. A semi-clean fluid passes a weir port (II) before entering a quiescent zone. From there, the semi-clean fluid passes through a first pump (A) on its way to Stage 3.

A typical reactor tank may communicate for example with multiple, e.g., three first sub-assemblies.

At Stage 1, upstream of the reactor, a coagulant and a diluted polymer are added to the influent either ahead of the reactor in a feed line, or within the reactive blanket. The polymer is preferably diluted with fresh water or treated wastewater, in one example to a concentration of <0.5% by volume before use.

The reactive blanket includes coagulated and flocculated solids and is maintained at a concentration in one example of about 1 g/L magnetite. A low-speed agitator (mixer) continually brings the solids into contact with the fresh wastewater, polymer and coagulant. A weir in the reactor vessel separates the blanket from a quiescent zone.

Fluid from the quiescent zone (e.g., approx. 175 gpm) is transferred by the first pump (A) to a set of first sub-assemblies that have an array of self-cleaning magnets. Any remaining magnetic sludge is returned to the reactive blanket during a purge cycle of the first sub-assembly (e.g., 1-2% fluid flow). Forward flow from the bank of first sub-assemblies is preferably about 98-99% of the feed flow. Clean fluid is discharged at an effluent port (V).

Solids content in the reactive blanket is maintained by periodic removal through a port VIII of sludge by a second pump (B). The pump effectively destroys the sludge flocculant, releasing magnetic particles from the non-magnetic solids. The waste sludge (IX) is passed through a bank of drum-type second sub-assemblies, which collect the magnetic particles and returns them to the reactive blanket. Remaining solids are transferred to a sludge dewatering stage (Stage 5).

Preferably, the dewatering step involves use of a receptor such as a membrane bag which acts as a sieve or filter. In one example, the membrane bag is sized for a 20-yard dumpster. If needed, additional polymer and or coagulant may be added. When desired, the membrane bag with solids is hauled to a landfill and replaced with a fresh membrane bag.

### Examples

In one set of experiments, a 1.6 gpm pilot unit was configured with five sections. A (250 L) feed tank and pump delivered feed stock to a 28 L reactor core. Magnetic iron (600 g) was added to the reactor. Additives including polymers and a coagulant were fed continuously into the reactor. A mixer within the reactor kept the active iron blanket in suspension. Feed to the reactor was delivered continuously at a rate of about 7 L/m below the top of the reactive iron blanket. Discharge from above the reactive iron core was sent to a stilling well to pre-capture iron ahead of the first sub-assembly which may be embodied in variants of a product named Maggie® made by Zero Gravity Filters in Brighton, Mich. One purpose of the first sub-assembly is to capture at least some magnetic contaminants before effluent discharge.

In one pilot unit, the first sub-assembly was gravity-fed. At the end of a test run, the reactor contents were gravity fed through the second sub-assembly which may be embodied in variants of a product named Smart Drum, also made by Zero Gravity Filters in Brighton, Mich. to capture more iron for reuse as a charge to the reactor. In one conceptual design of a full-scale unit, operation of the solution feed, polymer feed, iron reuse, and non-magnetic flocculant separation is expected to be automated.

A three-day pre-trial of the pilot unit has occurred. The feed stock included 120,000 ppm; 80,000 ppm; and 40,000 ppm of sodium chloride. The feed solids (400 mg/L TSS) included a mix of calcium carbonate (70%), calcium hydroxide (10%); barium sulfate (10%), bentonite clay (8%) and oil (2%), representing an approximation of the materials expected to be encountered in the field. This waste mix is typical of many produced waters generated in natural gas production.

Experiments revealed that
a. there are cationic polymers that can actively flocculate suspended solids at TDS levels up to 120,000 ppm;
b. the process can be operated at a nominal reaction time of 5 minutes;
c. an active iron blanket can be maintained exceeding 90 g/L powdered iron;
d. a total of 1800 g of iron were loaded to the reactor over three tests. Only 132 grams iron were recovered in the stilling well, while the total iron collected in the first sub-assembly was only 16 grams. At the end of each test, the 28 L reactor was dumped to the second sub-assembly, which recovered in excess of 99% of the iron.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A process for removing suspended solids from a contaminated fluid, comprising the steps, not necessarily in the sequence disclosed, of:
a. dosing the contaminated fluid with one or more additives to create a modified fluid, the additives being selected from the group consisting of a magnetic material, a polymer and a coagulant aid;
b. providing a reactor for receiving the modified fluid wherein a reactive sludge blanket is formed within the reactor and wherein a weir is located within the reactor, the reactor producing a semi-clean fluid;
c. providing a first sub-assembly with one or more shuttle-type self-cleaning magnets that remove an amount of magnetic material from the semi-clean fluid, the semi-clean fluid being subjected to the influence of one or more magnets associated with the first sub-assembly, so that any magnetic material carrying non-magnetic solids within a floc is substantially unperturbed to encourage the collection of the magnetic and non-magnetic material in the flocculant within a field of the magnets associated with the first sub-assembly;
d. creating a separated fluid volume of the semi-clean fluid from the magnets, the separated fluid volume being essentially free of debris and being adapted to be discharged to a subsequent process step;
e. cleaning the magnets associated with the first sub-assembly to form a retentate; and
f. forwarding the retentate to the reactor containing the reactive sludge blanket.

2. The process of claim 1, further comprising the steps of:
g. passing sludge containing magnetic and non-magnetic material from the reactor to a second subassembly with a magnetic drum;
h. shearing non-magnetic material from the flocculant containing magnetic and non-magnetic materials so that the one or more magnets associated with the second sub-assembly further separate magnetic material from nonmagnetic material;
i. creating a further modified fluid from the sludge;
j. recycling a desired portion of magnetic material by returning the magnetic material to the reactor; and
k. separating further non-magnetic material using a dewatering device.

3. An assembly for treating contaminated fluid following the process steps of claim 1, the assembly having:
a first stage with at least one of polymer make-up and coagulant feed units plus a dilution means;
a second stage with a reactor including a tank with a weir and a mixer;
a third stage with one or more first sub-assemblies of self-cleaning magnetic shuttles that capture at least some magnetic flocculant that escapes from the second stage;
a fourth stage with one or more second sub-assemblies for separating magnetic particles from the flocculant, returning at least some of the magnetic particles to the reactor, and sending non-magnetic solids to a dewatering stage; and
a fifth stage having a dewatering step, where incoming solids are optionally treated with a coagulant and flocculant to aid the dewatering step, remaining solids being sent to a site for disposal.

4. The assembly of claim 3, wherein at least one of the first sub-assemblies of self-cleaning magnetic shuttles have a self-cleaning feature that includes:
means for energizing an actuator that directs a flow of fluid that enters the first sub-assembly at an influent port;
a logic module that initiates a self-cleaning cycle on a timed basis by rotating a valve that changes direction of the fluid flow from a normal discharge port to a waste discharge port; and
a source of pneumatic pressure that moves the magnetic shuttles from a bottom region of the first shuttle-type sub-assembly to a top region of the first shuttle-type sub-assembly; the logic module rotating the valves so that the first shuttle-type sub-assembly returns to normal flow through a forward flow discharge port.

5. The assembly of claim 3, wherein the first sub-assembly of self-cleaning magnetic shuttles and the second drum-type sub-assembly are mounted externally outside the reactor, thereby facilitating maintenance.

6. An assembly for treating a contaminated fluid following the process steps of claim 1, the assembly having a first sub-assembly with a magnetic separator for separating magnetic material from a contaminated fluid and a second sub-assembly with a drum-type magnetic separator, the first sub-assembly including
at least one tube portion disposable in a fluid flow path;
a magnet within the tube portion movable between a separator position in the tube portion and a release position in which the magnet is withdrawn from the tube portion;
wherein the magnet is in the form of a shuttle and the tube portion is part of a longer tube disposable within the flow path;
whereby the magnet moves between its positions by differential pressure being created across the magnet; and
a logic module in communication with actuators that influence an outlet valve for directing the fluid in a first direction when the shuttle is in its separator position and in a second direction when the shuttle is in its cleaning position.

7. The assembly of claim 6 wherein there is a plurality of tubes and at least one magnetic shuttle in each tube.

8. The assembly of claim 7 wherein the tubes are arranged in a general circular array.

9. The assembly of claim 8 wherein the tubes are disposed in a generally annular chamber.

10. The assembly of claim 9 further comprising a baffle plate.

11. The assembly of claim 10 wherein the baffle plate includes apertures to allow fluid flow between the tubes.

12. The assembly of claim 6, wherein at least one of the tubes include a linear array of magnets and seals at either end of the array for sealing with an inner face of the tube.

13. The assembly of claim 6, wherein a valve supplies compressed air to the tube to move the shuttle between its positions.

14. The assembly of claim 6 further wherein the baffle plate has one set of apertures for receiving the tubes and another set of apertures to allow fluid flow there between.

15. The assembly of claim 6, wherein the tube is disposed in a chamber divided by a baffle plate through which the tube extends, and the cleaning position lies upstream of the baffle, and the separator position lies downstream of the baffle.

16. The assembly of claim 3, wherein there are multiple second sub-assemblies in communication with a first sub-assembly.

17. The assembly of claim 3, further including a mobile platform upon which the assembly is mounted in order to enable mobility of the assembly.

18. The assembly of claim 3, wherein the assembly of first and second sub-assemblies includes a purge line through which at least some solids travel from the first sub-assembly, the purge line being connected to an influent port of the second sub-assembly via the reactor.

19. The assembly of claim 18, wherein the sub-assemblies can run in parallel, rather than in series.

20. The assembly of claim 18, wherein the sub-assemblies can run independently of each other.
